(19) United States
(12) Patent Application Publication
(10) Pub. No.: US 2026/0238857 A1
(43) Pub. Date: Aug. 13, 2026

(54) METHOD AND SYSTEM FOR PLAYBACK-SYNCHRONIZED, SUBTITLE-STYLE VERACITY OVERLAYS FOR ASSERTIONS IN DIGITAL MEDIA

(71) Applicant: Avi S. Tuschman, Lahaina, HI (US)

(72) Inventor: Avi S. Tuschman, Lahaina, HI (US)

(21) Appl. No.: 19/534,584

(22) Filed: Feb. 9, 2026

Related U.S. Application Data
(60) Provisional application No. 63/756,582, filed on Feb. 10, 2025.

(51) Int. Cl. H04N 21/4722; H04N 21/43; H04N 21/466; H04N 21/8547

(52) U.S. Cl. CPC H04N 21/4722; H04N 21/43074; H04N 21/466; H04N 21/8547

(57) ABSTRACT

A computer-implemented method and system provide real-time verification of asserted statements during consumption of digital media. A client device presents media from a host platform and identifies asserted statements expressed in the media. A verification engine obtains information from external reference sources, including via network retrieval, and generates veracity assessments for at least a subset of the asserted statements using automated verification algorithms and/or artificial-intelligence models. During ongoing presentation of the media, the client device displays veracity assessments in temporal alignment with corresponding asserted statements as a synchronized overlay, without modifying host-platform source code or requiring privileged integration. In some embodiments, veracity assessments are cached and reused across subsequent viewings based on retention policies to reduce latency and redundant computation.

### CROSS-REFERENCE TO RELATED APPLICATIONS

This application claims the benefit of U.S. Provisional Application No. 63/756,582, filed Feb. 10, 2025, the contents of which are hereby incorporated by reference in its entirety.

### FIELD OF THE INVENTION

The present invention relates to computer-implemented systems for real-time fact-checking of asserted statements in digital media, including synchronized overlay presentation during media playback without modification of host platform software.

### BACKGROUND OF THE INVENTION

Digital and social media platforms distribute video, audio, and other digital media to mass audiences through continuously updated feeds, playback pages, and reading views. While such platforms enable rapid access to information, they also facilitate rapid dissemination of incorrect, misleading, or unverified assertions expressed within the media itself.

Conventional fact-checking techniques typically operate outside the media consumption experience and do not provide real-time, in-stream fact-checking as media is being consumed. For example, users may be required to interrupt playback or reading to open separate browser tabs, navigate to external websites, or review post-publication fact-checking articles. Such approaches are not synchronized to the timing of individual assertions within the media and discourage timely engagement with verification results as the claims within said media are consumed in situ on mass media platforms with up to billions of monthly active users.

Where fact-checking mechanisms are integrated into mass digital media platforms with billions of monthly active users, they are generally applied at an aggregate level, such as to an entire video, post, or article, rather than providing real-time fact-checking of individual asserted statements as those statements occur during and within the consumption of video and audio media. In addition, such mechanisms are typically asynchronous, relying on delayed review processes that deliver fact-checking results only after the media has already been consumed and widely shared, with each additional hour until fact-check labeling increasing the spread of misinformation and disinformation.

Existing approaches further fail to scale to modern media formats that may contain numerous asserted statements per minute of video or audio. The time and computational cost associated with manual or delayed review limits the feasibility of performing real-time fact-checking at the level of individual assertions during playback.

Many existing solutions also require modification of host platform software, privileged integration, or user navigation away from the feed, page, or tab in which the media is presented. Such requirements interfere with platform operation and prevent seamless, in-context delivery of real-time fact-checking results.

Finally, conventional systems generally do not reuse fact-checking results efficiently across users. Even when an asserted statement associated with particular media content has already been fact-checked, subsequent viewers often experience the same verification latency or must independently seek out fact-checking information, preventing timely, real-time presentation of verification results.

Accordingly, there exists a technical need for systems and methods that enable real-time fact-checking of asserted statements as digital media is consumed, that scale to mass-audience media formats, that operate without modifying host platform software or requiring user navigation away from the media, and that efficiently reuse fact-checking results to reduce latency for subsequent viewers.

### SUMMARY OF THE INVENTION

The present disclosure provides computer-implemented systems and methods for real-time verification of asserted statements expressed in digital media, and for presenting corresponding veracity assessments in temporal alignment with the asserted statements during media consumption.

In various embodiments, digital media content supplied by a host platform is presented within a feed, playback page, or reading view, and one or more asserted statements expressed within the media are identified and verified against external reference sources while the media is being presented. For at least a subset of the asserted statements, a veracity assessment is generated and made available during ongoing presentation of the media.

Veracity assessment results are presented as a synchronized, subtitles-like overlay that appears while a corresponding asserted statement is being presented and disappears when the asserted statement is no longer being presented. The overlay is rendered in-stream without requiring a user to leave the feed, page, or tab, thereby enabling seamless, in-context verification during media consumption.

The disclosed systems and methods operate independently of the host platform, including without modifying source code of the host platform or altering its recommendation, ranking, or advertising logic, allowing deployment across platforms while preserving platform integrity and user experience.

In various embodiments, veracity assessments associated with particular media content are stored and reused for subsequent presentations of the same media, enabling faster verification for later viewers, reducing redundant computation, and lowering system latency during playback.

In some embodiments, presentation of the synchronized overlay is conditional, such that the overlay remains dormant unless one or more asserted statements satisfy predefined significance or prioritization criteria, thereby reducing visual clutter and unnecessary processing.

It is one aspect to provide a computer-implemented method for real-time verification of asserted statements during consumption of digital media, comprising: (a) presenting, at a client device, digital media content supplied by a host platform within a continuous media feed, playback page, or reading view; (b) identifying, during presentation of the digital media content, one or more asserted statements expressed in the digital media content; (c) verifying at least a subset of the asserted statements against information obtained from one or more external reference sources to generate, for each verified asserted statement, a veracity assessment; (d) during ongoing presentation of the digital media content, displaying the veracity assessment for a verified asserted statement in temporal alignment with the asserted statement, as an overlay that appears in a subtitles-like manner while the asserted statement is presented; and (e) performing the displaying without requiring modification of source code of the host platform, without requiring a partnership or privileged integration with the host platform, and without requiring a user to leave the feed, page, or tab in which the digital media content is presented.

It is another aspect to provide a system for real-time verification of asserted statements during consumption of digital media, comprising: one or more processors; and one or more non-transitory computer-readable media storing instructions that, when executed by the one or more processors, cause the system to: (a) present, at a client device, digital media content supplied by a host platform within a continuous media feed, playback page, or reading view; (b) identify, during presentation of the digital media content, one or more asserted statements expressed in the digital media content; (c) verify at least a subset of the asserted statements against information obtained from one or more external reference sources to generate, for each verified asserted statement, a veracity assessment; (d) during ongoing presentation of the digital media content, display the veracity assessment for a verified asserted statement in temporal alignment with the asserted statement, as an overlay that appears in a subtitles-like manner while the asserted statement is presented; and (e) perform the displaying without modifying source code of the host platform, without requiring a partnership or privileged integration with the host platform, and without requiring a user to leave the feed, page, or tab in which the digital media content is presented.

It is yet another aspect to provide a non-transitory computer-readable medium storing instructions that, when executed by one or more processors of a client device or a computing system in communication with the client device, cause the one or more processors to: (a) present, at the client device, digital media content supplied by a host platform within a continuous media feed, playback page, or reading view; (b) identify, during presentation of the digital media content, one or more asserted statements expressed in the digital media content; (c) verify at least a subset of the asserted statements against information obtained from one or more external reference sources to generate, for each verified asserted statement, a veracity assessment; (d) during ongoing presentation of the digital media content, display the veracity assessment for a verified asserted statement in temporal alignment with the asserted statement, as an overlay that appears in a subtitles-like manner while the asserted statement is presented; and (e) perform the displaying without modifying source code of the host platform, without requiring a partnership or privileged integration with the host platform, and without requiring a user to leave the feed, page, or tab in which the digital media content is presented.

Collectively, the disclosed systems and methods provide a technical improvement to client-side media playback systems by enabling real-time, time-synchronized verification of asserted statements during media presentation without modifying host-platform software. Through time-interval mapping, client-side overlay control, backend caching, and threshold-based activation, the invention improves playback efficiency and responsiveness while reducing verification latency and redundant computation, rather than merely presenting information separate from the media consumption process.

### BRIEF DESCRIPTION OF THE DRAWINGS

FIG. 1 is an image illustrating that clicking on the extension in a video displays fact checking panel and the on-off toggle;

FIG. 2 is an image illustrating that clicking on a company logo placeholder displays the scoring game legend;

FIG. 3 is an image illustrating that playing a video brings up the overlay display;

FIG. 4 is an image illustrating that a video plays normally when there are no major or controversial assertions;

FIG. 5 is an image illustrating a video playing during a major assertion that is “Correct;”

FIG. 6 is an image illustrating that pausing the video brings up a short explanation window;

FIG. 7 is an image illustrating that clicking on video collapses the overlay and restarts the video;

FIG. 8 is an image illustrating the occurrence of a major assertion that is “Mostly Wrong;”

FIG. 9 is an image illustrating that pausing a video brings up a short explanation window;

FIG. 10 is an image illustrating that clicking on a link opens a new web browser;

FIG. 11 is an image illustrating the “All assertions” button;

FIG. 12 is an image illustrating that clicking on an “All assertions” button opens an overlay;

FIG. 13 is an image illustrating that each assertion can expand to show timestamps, explanations, and links without altering the video;

FIGS. 14 and 15 are image and image, respectively illustrating how, after a user has opened a video, other users can immediately see overall scores and explanations;

FIG. 16 is a schematic of one embodiment of client device to be provided with real-time assertion verification and display; and

FIG. 17 is a schematic that illustrates an example system architecture for real-time extraction, verification, and presentation of asserted statements in digital media content, including interactions between a client device, a backend assertion extraction and verification system, and one or more external information sources.

### DETAILED DESCRIPTION

The methods described herein operate on a processing system that may include a processor, memory, storage for at least programs, a display, and an interface to a network, which in some embodiments is the Internet. The processing system is part of a user's media consumption environment, and the embodiments described herein are designed to integrate into the user's media consumption environment. Such an environment may be a desktop web browser, a mobile web browser, an existing mobile application, a new mobile application, a smart TV application or interface, an augmented or virtual reality headset or glasses, and so forth. Incorporating the embodiments described herein may not require back-end modifications to the media platform. In some embodiments, the system interacts with the host platform only via documented client-side interfaces and does not modify or execute code on host-platform servers, including recommendation or ranking services. In some versions, the integration of an embodiment of the invention may be achieved via one or more of client-side browser extensions, plug-ins, standalone applications, or embedded code that interacts seamlessly with an existing media player environment.

As discussed herein, certain embodiments of the methods and systems described herein automatically verify and categorize factual assertions made within digital media by one or more of: 1) determining one or more assertions made in the digital media in an assertion extraction engine; 2) verifying the veracity of the assertions in a verification engine; and 3) presenting veracity of the qualified assertions to a user in a display interface.

### DEFINITIONS

As used in this disclosure, certain terms are defined below for clarity and consistency. These definitions are provided to assist in understanding the disclosed embodiments and are not intended to limit the scope of the invention except as expressly set forth in the claims. Unless otherwise indicated, terms used herein are to be given their ordinary and customary meaning as understood by a person of ordinary skill in the art at the time of the invention, in view of the entire disclosure.

As used herein, an “asserted statement” refers to a proposition expressed in digital media that conveys a factual statement, prediction, or opinion susceptible to verification against external reference information.

As used herein, a “curated set of reference sources” refers to a set of network-accessible information sources that are eligible to be used as reference material for verifying asserted statements. In some embodiments, the curated set is implemented as selection criteria and/or guardrails applied at retrieval time rather than a fixed repository. For example, the curated set may be defined by: source-type constraints (e.g., news, scientific, governmental, encyclopedic, or fact-checking sources), freshness or recency constraints, jurisdiction or language constraints, and/or reliability constraints. In certain embodiments, the system uses a general-purpose, including but not limited to depersonalized web search engine 1731 to retrieve candidate sources and then applies one or more filters (e.g., blocking or downranking domains that do not satisfy predetermined reliability criteria, including, but not limited to criteria derived from an independent third-party media ratings filter 1733) to yield the curated set used for verification.

As used herein, a “veracity score” refers to a quantitative value representing an estimated degree of factual correctness of an asserted statement. The veracity score may be expressed in any suitable range or scale (e.g., 0-1, 0-10, 0-100, or another bounded or unbounded numeric scale), and may be generated by a model, algorithm, rule set, or combination thereof. In some embodiments, the veracity score is computed from evidence obtained from one or more reference sources, optionally together with metadata such as confidence indicators, recency/volatility indicators, or source-consistency indicators.

As used herein, a “veracity category” refers to a discrete label selected from a predefined set of categories that characterize an asserted statement's estimated factual correctness. Example categories can include, without limitation, labels indicating that an asserted statement is accurate, partially accurate, misleading, incorrect, or not verifiable. In some embodiments, the veracity category is determined by mapping and/or thresholding rules applied to a veracity score and/or other features (e.g., evidence sufficiency, cross-source replication, contradiction detection among sources, or recency/volatility).

As used herein, a “significance or controversy score” refers to a quantitative metric indicating whether an asserted statement is expected to be sufficiently impactful, disputed, salient, time-sensitive, or otherwise noteworthy to warrant presentation of a veracity indicator. The significance or controversy score may be generated by an artificial-intelligence model, by heuristic rules, or by a combination thereof, and may incorporate factors such as topic, predicted user impact, degree of disagreement among reference sources, and/or temporal volatility.

As used herein, a “media identifier” refers to a value that uniquely or stably identifies a unit of media content within a host platform or system. A media identifier may include, without limitation, a platform-specific content ID (e.g., a video ID), a canonical URL, a normalized key derived from a URL, a composite key including a platform identifier and platform-specific content ID, and/or a content-derived identifier such as a hash of transcript/captions data or another canonical representation of the media content.

As used herein, “real-time assertion verification and display” refers to presenting one or more veracity assessment results for an asserted statement during presentation of the media content, such that a veracity indicator is displayed in temporal alignment with the asserted statement (e.g., while the asserted statement is being spoken, shown, or otherwise presented, or within a short time window associated with the asserted statement). In some embodiments, “real-time” includes operation within a time budget suitable for interactive playback, including where certain processing is performed in advance and/or via caching and where updated assessments may be displayed asynchronously (e.g., stale-while-revalidate) without materially interrupting playback.

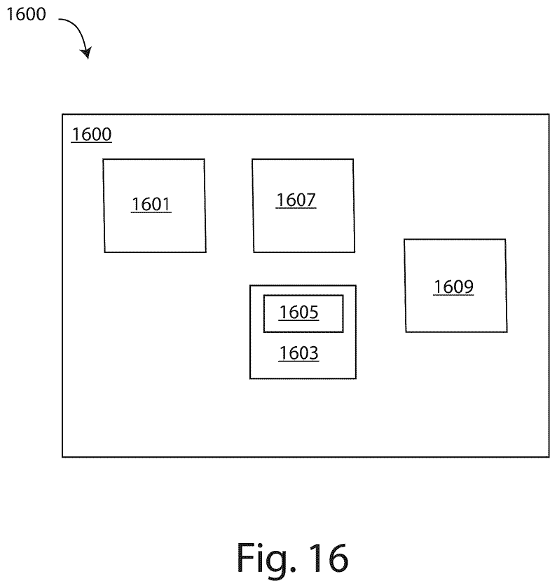

FIG. 16 is a schematic of one embodiment of a client device 1600 configured to be provided with real-time assertion verification and display. Client device 1600 forms part of a user's media consumption environment and may include, by way of example and without limitation, a mobile device such as a smartphone, laptop, or tablet, a desktop computer, or a smart television. Client device 1600 includes a processor 1601, a memory 1603 for digital storage and including, but not limited to, at least one program 1605, a display 1607, and an interface 1609 to a network (the network not shown). At least one of the programs 1605 comprises program instructions that, when executed by processor 1601, cause client device 1600 to perform one or more of the methods described herein.

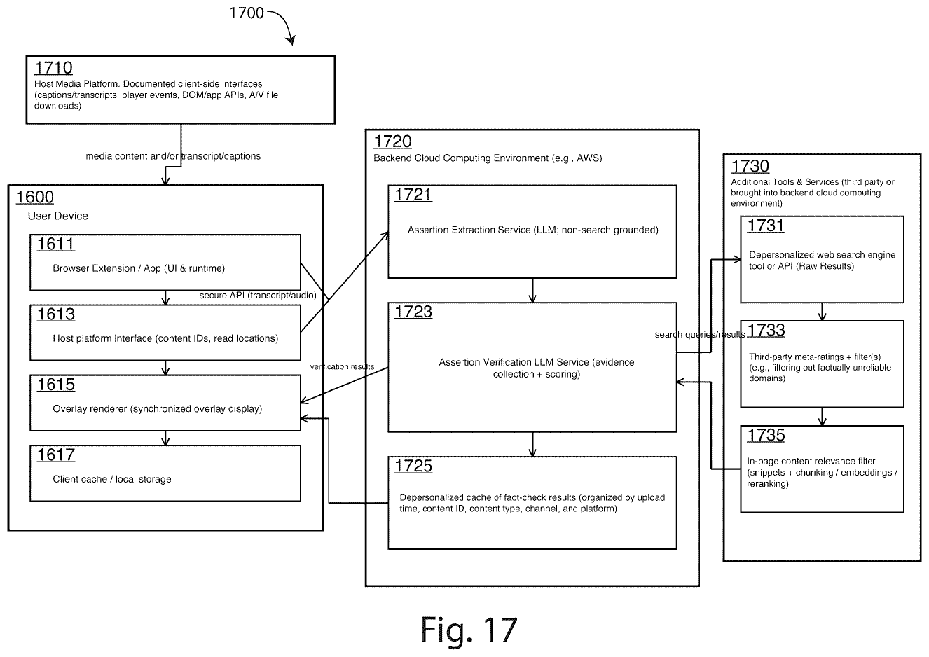

By way of example and without limitation, FIG. 17 is a schematic illustrating an example system architecture and data flow 1700 for automatically identifying, verifying, and presenting veracity information for asserted statements made within digital media content. FIG. 17 includes a user's client device 1600 having a browser extension or application 1611, a host platform interface 1613, an overlay renderer 1615, and a client cache or local storage 1617, which utilize processor 1601, memory 1603, display 1607, and interface 1609 as discussed above.

FIG. 17 also includes a host media platform 1710, and a backend cloud environment 1720 including, but not limited to, an assertion extraction engine 1721, an assertion verification engine 1723, and access to one or more additional (external) services 1730 including a depersonalized web search engine 1731, a third-party media ratings filter 1733, and an in-page content-relevance filter, 1735, that handles web-page deep reads using one or more techniques to identify, select, or rank relevant portions of retrieved documents, to reduce noise and increase efficiency. As used herein, “web-search-grounded” refers to operation in which an artificial-intelligence model (e.g., an LLM) is presented with outputs from a web-search tool, and reviews one or more of the external reference sources before returning a response, rather than basing a response on only internal generation.

Client device 1600 executes browser extension or application 1611, which comprises client-side software instructions configured to monitor media playback and manage local execution of overlay presentation logic. Host platform interface 1613 is configured to interact with backend cloud environment 1720 through documented application programming interfaces, exposed markup, or standard media playback controls. Overlay renderer 1615 is configured to present assertion-related graphical indicators on display 1607 in coordination with media playback without modifying the underlying media stream. Client cache or local storage 1617 is configured to store assertion data, veracity information, and related metadata for reuse and reduced latency in databases or in other data structures.

Further in FIG. 17, host platform 1710 supplies digital media content to client device 1600 via the host platform interface 1613 without being modified by the systems described herein. In the illustrated embodiment, client device 1600 passes media content (captions, transcript, or temporarily downloaded video or audio content that may be immediately erased after passing it to the backend) to an assertion extraction engine 1721 on the backend cloud environment 1720, and the backend cloud environment further executes an verification engine 1723 to evaluate extracted asserted statements and generate corresponding veracity information. The veracity information includes assertion text, which is obtained from assertion extraction engine 1721, and the output from verification engine 1723, may include (a) a veracity category selected from a predefined set of categories, (b) a numeric score within a defined range, where the score is mapped to the veracity category, (c) an optional rationale string to justify and explain the veracity category, while bringing in additional context from the ground-truth sources, and (d) links to the ground truth sources themselves, which in some embodiments may be filtered by third-party factual-reliability media ratings.

### Assertion Extraction Engine

One aspect of the invention is assertion extraction engine 1721 that extracts relevant content from the source of media to be analyzed. For video or audio content, transcripts may be obtained via platform or third-party APIs, or downloaded and then processed through automated sound-to-text transcription software or APIs to such transcription software. For text-based media such as news articles, blog posts, social media feeds, and so forth, the assertion extraction engine 1721 may analyze textual content directly. For image-based content, one embodiment extracts associated captions and may use optical character recognition (OCR) to extract the text.

Once the relevant language content is extracted in text form, the assertion extraction engine 1721 identifies and selects a subset of asserted statements present in the digital media. In one embodiment, the selected asserted statements correspond to factual statements, which may also include significant opinions and predictive statements, that are then assessed by assertion extraction engine 1721 as being central to an argument expressed in the digital media and consequential if incorrect, as determined using one or more prioritization criteria. The assertion extraction engine 1721 may further regulate a selection rate, such as selecting a predetermined number of asserted statements per unit of media duration.

In certain embodiments, assertion extraction engine 1721 applies a temporal normalization or rate-limiting constraint to control the density of selected asserted statements. For example, the system may be configured to select approximately one to five asserted statements per predetermined media interval, such as per minute or per two minutes of video content. Such constraints may be fixed, user-configurable, or dynamically adjusted based on media length, speaking rate, or detected assertion density, thereby avoiding excessive or insufficient assertion selection.

Embodiments of the invention include a Generative AI model that can be part of the processing system, or in some embodiments, the system may communicate with such a model via API. Generative AI models such as large language models (LLMs), e.g., commercially available or proprietary large language models, open-source large language models, and/or other artificial-intelligence models. Note that models or distilled versions thereof may be compressed and can operate in relatively small processing systems. The model (in the system, or external) may be communicated with specific prompts designed to identify not only the most important and consequential assertions in the digital media, but also contextually relevant statements that have factual content susceptible to verification and/or comparison with a more complete factual record compiled from many different sources, which can be filtered by independent factual-reliability ratings. These assertions are timestamped or context-labeled so they can be aligned with corresponding media playback or display times. Such assertions are called qualified assertions.

In certain embodiments, one or more prompts provided to a generative AI model cause the system to (i) identify a limited number of asserted statements expressed in the transcript of audiovisual content, (ii) output each identified asserted statement as a concise statement, and (iii) associate each asserted statement with corresponding temporal information from the content (e.g., timestamps). In some embodiments, the prompt further constrains the model to return the results in a structured, machine-readable format.

In the assertion extraction stage, assertion extraction engine 1721 receives, as inputs via the host platform interface 1613, media-derived content associated with a media item, including one or more of: captions, a transcript (optionally time-aligned), and/or temporarily downloaded audio or video content, together with optional metadata such as a title, a media identifier, and an upload or publication date. The assertion extraction engine 1721 produces, as input to verification engine 1723, a structured object comprising an array of extracted asserted statements, each asserted statement including: (a) an asserted statement text field representing a normalized factual proposition identified in the media, and (b) a start time and an end time field defining a corresponding time interval in the media timeline for synchronized display.

In the assertion extraction stage, assertion extraction engine 1721 may be configured such that the number of extracted asserted statements produced as output is fixed or configurable, for example limited to approximately 1-5 asserted statements per standardized media segment length, such as per two minutes of video. The asserted statement text fields included in the output may be subject to one or more brevity or formatting constraints, including a maximum word count and/or single-statement formatting, to facilitate deterministic processing and display. The start time and end time fields output for each asserted statement may be represented at a selected temporal resolution, such as seconds or fractions thereof. The structured output generated by assertion extraction engine 1721 may be encoded in JSON or an equivalent machine-readable format.

### Verification Engine

Embodiments of the invention include verification engine 1723 to verify the qualified assertions. In one embodiment, the qualified assertions are verified by cross-referencing them against a set of trusted ground-truth sources, such as live web-search results from depersonalized web search engine 1731, that may be curated or may be otherwise qualified, e.g., by an AI system such as an LLM. In some embodiments, such sources need to meet inclusion criteria based on deterministic filters created from independent third parties'factual-reliability ratings. Examples of trusted ground-truth sources include, but are not limited to, reputable encyclopedic domains (e.g., English-language pages on en. Wikipedia. org with large unique contributor counts), major news agencies (e.g., reuters.com, apnews.com), recognized fact-checking organizations (e.g., factcheck. org, politifact.com, snopes.com), and authoritative scientific and health organizations (e.g., mayoclinic.org, who.int, nature.com, sciencemag.org), as well as other web domains with a reputation for fact checking, accuracy, and a neutral point of view.

Each qualified assertion is then inputted into a Generative AI model with structured output prompts to produce a quantitative veracity score. In one embodiment, the scores are numeric, e.g., 0 for completely false to 100 for completely true. Furthermore, in some embodiments, the Generative AI model further or alternatively assigns a qualitative categorization bucket. One set of such categorization buckets may include such categories as “Correct,” “Partly Right,” “Misrepresented,” “Mostly Wrong,” and “False”. Additional contextual metadata, such as confidence intervals, the count of sources supporting the assertion, or references to specific authoritative sources and their media ratings, may be included in some embodiments to enhance transparency and reliability.

In certain embodiments, one or more prompts to a generative AI model cause the system to evaluate a single extracted asserted statement against information retrieved from two or more external sources and to output (i) a veracity categorization and (ii) a quantitative veracity score corresponding to that categorization, optionally accompanied by a brief natural-language rationale.

Inputs to verification engine 1723 may be provided by assertion extraction engine 1721 and may include the asserted statement text (and optional contextual metadata such as title, date, and additional disambiguating context from the transcript). Outputs from verification engine 1723 are provided to client device 1600, via the Overlay Renderer 1615, and may include a structured object comprising: (a) a veracity category selected from a predefined set of categories, and (b) a numeric score within a defined range, where the score is mapped to the veracity category, and (c) an optional rationale string to justify and explain the veracity category, while bringing in additional context from the ground-truth sources, and (d) links to the ground truth sources themselves, which in some embodiments may be filtered by third-party factual-reliability media ratings. In some embodiments the third-party factual-reliability ratings of post-filter ground-truth articles'domains may be surfaced via the Overlay Renderer 1615, for users to see in association with these article links that are related to the claim and its veracity categorization and/or veracity score.

Labels for categories, ranges, or constraints may be drawn from a fixed set (e.g., Correct, Partly Right, Misrepresented, Mostly Wrong, False, and Unable to Verify). Scores may be integers (e.g., 0-100) or a Not Enough Evidence (NEE) value in the case of abstention. The mapping between labels and score bands may be fixed or configurable. Output may be constrained to a deterministic schema (e.g., JSON with specified keys) and to a bounded explanation length.

### Native Integration for Display Interface

Verification information is provided backend cloud environment 1720 to client device 1600 via host platform interface 1613 and is displayed on display 1607 by overlay renderer 1615 according to programming 1605. In one embodiment, results of a veracity assessment outputted by the assertion verification engine 1723 are rendered as a non-disruptive overlay synchronized with the media content's timeline. For example, if an assertion spans the time 0:00:07 to 0:00:18 in a video, the overlay would appear during at least that window, showing, in one embodiment, the assertion's summarized text, veracity category, and a color-coded indicator (e.g., green for “Correct,” red for “False”) along with the numerical score. In one embodiment, pausing the underlying media may trigger an expanded view revealing more detailed fact-check information, links to ground-truth references, and an explanation, preferably succinct, for the given veracity assessment. In one version, unpausing collapses this view, returning to the minimal overlay to avoid cluttering the user experience.

In this version, this mechanism enables user interaction with the host platform's user interface (UI) to alter the functionality of the fact-checking overlay; and it also ensures that user interaction with the fact-checking overlay will not alter the functionality of the host platform's core functionality or services, thereby for example maintaining compliance with common terms of service of host platforms.

In some embodiments, the overlay remains hidden until a qualified assertion is detected. In others, a user interface button allows audiences to view all verified assertions at once, sorted by their chronological order or by their veracity score and veracity category.

### Unaltered Platform Operation

In one embodiment, the system operates independently of the platform's internal methods. It does not alter the platform's underlying architecture, does not inject changes into the platform's codebase, and does not interfere with the platform's advertising or other monetization streams, or with content recommendation engines. Such a system embodiment does not alter the overall user experience of the host platform, whose core functions operate normally underneath the overlay.

In one embodiment, the system performs assertion verification while preserving unaltered operation of the host platform. Verification processes occur in verification engine 1723 and then are displayed on the user's client device 1600 and/or via secure application programming interfaces, without modifying the host platform's internal architecture, codebase, recommendation logic, advertising services, or monetization mechanisms. The system operates such that verification functionality is layered over the media presentation while the core functions of the host platform continue to operate normally.

In some embodiments, the system limits collection and use of user-related data to what is necessary for session handling, billing, tax, or aggregate statistical purposes, without associating persistent user profiles with media browsing behavior or assertion evaluation results, thereby supporting privacy-preserving operation consistent with data-minimization principles. In further embodiments, fact-checking outputs associated with particular media content are stored in a depersonalized cache of fact-check results 1725 for a predetermined period and retrieved when the same media content is encountered again, reducing redundant verification processing and improving latency during subsequent media presentations.

### Time-Interval Mapping and Overlay Control

In some embodiments, the host application exposes current playback time information via a media playback interface, such as an HTML5 video element or a native media control API, and the client device 1600 periodically or continuously obtains a current playback timestamp from this interface. Upon identifying an asserted statement expressed in the digital media content, assertion extraction engine 1721 assigns the asserted statement to a corresponding time interval in the media timeline, the time interval being defined by a start timestamp and an end timestamp associated with when the asserted statement is presented.

The corresponding time interval may be determined in various ways. For example, the time interval may be derived based on speech timing, token alignment, or frame indices associated with the media content. In some embodiments, the time interval is estimated by a large language model (LLM) operating assertion extraction engine 1721 based on a granularly timestamped transcript obtained from a first-party or third-party API. In other embodiments, a granularly timestamped transcript is generated by processing an audio portion of the media content through a speech-to-text transcription model (e.g., an LLM-based transcription system), which outputs transcript text aligned with playback timestamps.

The overlay rendering component monitors the current playback timestamp during presentation of the digital media content and determines which, if any, asserted statements are active by comparing the current playback timestamp to stored start and end timestamps associated with the asserted statements. When the current playback timestamp falls within the time interval corresponding to a particular asserted statement, the overlay rendering component displays a synchronized overlay in temporal alignment with the asserted statement.

The synchronized overlay may be presented in a subtitles-like manner, appearing at approximately the same time as the asserted statement is spoken or otherwise presented, and may include one or more graphical indicators representing a veracity category and/or a veracity score. In some embodiments, the synchronized overlay further includes, or provides access to, a brief explanation associated with the asserted statement. When the current playback timestamp exits the corresponding time interval and no other asserted statements are active, the overlay rendering component hides or minimizes the overlay. In some embodiments, upon pausing playback while an asserted statement is active, a secondary overlay panel is displayed that presents additional explanatory text and one or more links to ground-truth reference sources.

### Caching and Reuse of Veracity Assessments

In one embodiment, the system stores in depersonalized cache of fact-check results 1725 previously generated assertion extractions and veracity assessments so that, upon later encounters with the same media content, the system can present results with reduced latency and reduced redundant computation. The stored artifacts may be de-personalized (i.e., not stored in cache in association with any user identity) and may be shared across user sessions.

### Media Identifier

The system associates each processed media item with a media identifier that uniquely identifies the media content on a host platform. The media identifier may include, without limitation, one or more of: a host-platform content ID, a canonical URL, a normalized URL-derived key, a content-hash (e.g., hash of a transcript/captions payload), and/or a composite key including platform name plus a platform-specific media ID. In some embodiments, a transcript/version hash is stored to detect later changes to the media's transcript/captions.

### Data Structure Storing Per-Assertion Data

For each media identifier, a record (or set of records) may be stored in depersonalized cache of fact-check results 1725 including, but not limited to: (i) a transcript/captions record, and (ii) one or more per-assertion records corresponding to extracted assertions within the media. A per-assertion record may store, without limitation: an assertion identifier; assertion text (or a canonicalized representation); a time interval (start time and end time) or other position indicator; a veracity categorization and/or quantitative score; an explanatory text; references to external sources or evidence pointers; a “recency/volatility” indicator (e.g., time-sensitive vs. non-time-sensitive); timestamps indicating when the assertion was last verified; and access media metadata used for cache organization and management. In some embodiments, an additional segment record maps a segment identifier to a set of assertion identifiers, enabling segment-level refresh and atomic updates of a segment's assertions.

### TTL/Refresh Policy

Cache entries stored in depersonalized cache of fact-check results 1725 may be governed by a refresh policy that depends on (a) the age of the media item (e.g., time since upload/publication) and/or (b) a per-assertion recency/volatility indicator produced by the verification process. In one embodiment, newer media and/or time-sensitive assertions are assigned shorter refresh intervals, while older media and/or non-time-sensitive assertions are assigned longer refresh intervals, such that the effective time-to-live (TTL) ramps as the media ages. In some embodiments, the refresh policy includes both a soft TTL (permitting “stale-while-revalidate,” in which cached results may be displayed while a refresh occurs asynchronously) and a hard TTL (requiring refresh before serving if exceeded), and may further include a “stale-if-error” interval that allows reuse of prior results if a refresh fails. In some embodiments, the policy may also include a time-to-idle eviction rule, under which cache entries that have not been accessed for a threshold idle duration are evicted to control storage growth. The refresh policy may be computed using metadata (e.g., upload date and the stored recency/volatility indicator) without requiring inspection of assertion content.

In one embodiment, transcript/captions artifacts are stored for an extended duration (including, in some implementations, indefinite caching), and the system may perform a one-time post-publication transcript re-fetch after a stabilization delay to detect whether the transcript/captions have materially changed. If a change is detected (e.g., by comparing a transcript/version hash), the system may re-run assertion extraction engine 1721 and verification engine 1723 for the affected media and update depersonalized cache of fact-check results 1725 accordingly.

### Behavior on Second Viewing

When the same media identifier is encountered again, the system may query the depersonalized cache of fact-check results 1725 and, if a cached record is available, immediately use the stored per-assertion veracity assessments to render synchronized overlays during playback and/or to pre-display an overall assessment prior to playback. If a soft TTL has been exceeded, the system may display the cached veracity assessments while initiating background re-verification and then update the overlays once refreshed results are received. If a hard TTL has been exceeded, the system may refresh the corresponding assertion (or segment) before presenting the refreshed results. In embodiments using segment records, the system may refresh an entire segment as a single unit when any assertion in that segment is indicated as time-sensitive, thereby reducing repeated work and maintaining consistency among related assertions.

### Dormant Overlay and Threshold Condition

In some embodiments, the overlay rendering component remains in a dormant or hidden state until a threshold condition is satisfied. Each asserted statement may be associated with a significance or controversy score, for example a numeric value indicating a predicted impact, contentiousness, likelihood of misunderstanding, and/or user interest associated with the asserted statement. The score may be generated by an artificial-intelligence model and/or derived using one or more rule-based criteria (e.g., topic-based weighting, recency/volatility classification, or source disagreement indicators). The system compares the significance or controversy score for each asserted statement to a predetermined threshold value (which may be configurable).

In one example algorithm, the threshold condition is satisfied when at least one asserted statement in a media item (or a current segment thereof) has a significance or controversy score exceeding the predetermined threshold value. If no asserted statement satisfies the threshold condition, the overlay rendering component can refrain from displaying veracity indicators during playback. When at least one asserted statement satisfies the threshold condition, the overlay rendering component transitions from the dormant state to an active state and displays one or more veracity indicators in temporal alignment with the corresponding asserted statement(s).

Thresholds may be tuned globally, per topic, per host platform, per media category, or per user preference, for example to cause the overlay to appear only for asserted statements predicted to be significantly disputed, time-sensitive, or likely to mislead. This behavior can reduce unnecessary visual clutter and preserve an uninterrupted viewing experience when no asserted statements satisfy the threshold condition.

### Channel/Publisher Ranking Computation

In various implementations, the system aggregates veracity assessments across multiple pieces of content associated with a common publisher or channel identifier. For example, the system can maintain, for each publisher or channel, a collection of veracity scores for asserted statements that appear in videos, articles, or other media published by that entity. The publisher or channel identifier can be derived from metadata provided by the host platform, such as a channel name, account identifier, or domain name.

An overall accuracy ranking or reliability score for a publisher or channel can be computed based on the aggregated veracity scores. In one embodiment, the system computes a weighted average of per-content scores, where weights can reflect factors such as view counts, recency, or number of assertions. In another embodiment, a weighted average can be calculated based on the scores of assertions over a rolling timeframe. All extracted assertions from all media, or the averages of all videos and/or all media posts, may be averaged over particular lookback windows. The resulting publisher or channel score can be presented to users in association with media items from that publisher or channel, for example as a badge, rating, or label shown adjacent to a channel name or thumbnail. This allows users to quickly assess historical reliability of content sources. In addition, a tamper-proof badge may be provided to content creators and media channels, which they can display to media consumers, including those who may not be using the invention described herein.

### Privacy/Data-Handling Implementation

In some embodiments, the system is configured to preserve user privacy by minimizing user-linked storage and by disassociating media-specific artifacts from user identity.

The system may store a minimal account identifier (e.g., an email address and/or internal user ID) and billing/usage accounting data sufficient to operate the service, such as a credit balance and credits consumed. In certain embodiments, the system may additionally store high-level aggregate consumption metrics (e.g., total minutes processed or total minutes of media during which the service was active), without storing which specific media items were consumed.

The system can be configured not to ever store any of the following in persistent association with a user identifier: user-identifiable browsing history; a watch/viewing history of specific media items; a list of media identifiers viewed by the user; transcript content linked to the user; per-user profiles derived from media consumption; or per-user veracity histories tied to particular media.

In some embodiments, the system enforces privacy-preserving handling of media and assertion data by limiting persistent associations between user identifiers and media-specific artifacts. Media identifiers, transcripts, extracted assertions, and veracity assessments are not persistently linked to a user identity beyond what is required for active processing during media presentation, thereby preventing reconstruction of a user's media consumption history from stored data.

In operation, the system may temporarily associate a media identifier and related artifacts with a session context solely for synchronizing overlays during an active viewing session, after which the association is discarded or expires after a short, configurable interval. Cached artifacts in depersonalized cache of fact-check results 1725, such as extracted assertions and veracity assessments, are stored in a de-identified, user-disassociated form, keyed by a media identifier and/or content hash rather than by a user identifier, such that cached verification results remain reusable across users without revealing user-specific viewing behavior.

In some embodiments, the system applies one or more of the following privacy-preserving policies:
Ephemeral session data: temporary session correlation identifiers and request metadata are discarded at session completion or after a short retention interval.
Aggregate-only analytics: operational telemetry is retained only at an aggregated level (e.g., counts of verifications performed, average latency, error rates, distribution of veracity categories, or total minutes processed across users) such that the retained analytics cannot reasonably be used to infer a specific user's viewing behavior.
Separation of concerns: accounting records (e.g., user ID and credits) are stored separately in depersonalized cache of fact-check results 1725 from media caches (media ID→transcript/assertions/veracity), with access controls and/or logical separation preventing persistent joins that would reveal user-specific media histories.
Configurable retention windows: retention intervals for logs and metrics may be configurable to enforce data minimization consistent with service operation, security, and performance.
Deletion/termination handling: upon account deletion, user-linked identifiers (e.g., email and internal user ID) and associated billing/accounting records are deleted or deactivated according to policy, while user-disassociated caches remain non-identifying and are not attributable to that user.

### High-Level Verification Pipeline (Search-Grounded AI)

In one embodiment, verification engine 1723 implements a multi-stage pipeline to generate veracity assessments for asserted statements using network-retrieved reference information and one or more artificial-intelligence models.

Upon receiving assertion text (and optionally associated metadata and context such as a media title, upload date, transcript segment, and/or named entities), verification engine 1723 makes one or more calls to a depersonalized web-search tool or search engine 1731. The search query may be produced by applying normalization and reformulation rules, a template, a prompt-based reformulation procedure, and/or an AI model that converts the assertion into a retrieval-oriented query. The verification engine 1723 may generate multiple candidate queries and select one or more based on predicted relevance and disambiguation quality.

The verification engine 1723 transmits the query to a retrieval service (e.g., a web search engine, index, or other network-accessible retrieval system) to obtain candidate results. The retrieval service 1731 returns passages, excerpts, documents, and/or structured facts. In some embodiments, verification engine 1723 applies eligibility criteria and guardrails to the returned candidates, such as filtering, downranking, or blocking sources based on predetermined reliability criteria (including criteria derived from independent third-party media ratings filter 1733), recency constraints, language constraints, and/or topical relevance, thereby forming a set of retrieved reference passages used for verification.

The verification engine 1723 provides the asserted statement and at least a portion of the retrieved reference passages to one or more AI models to produce a veracity assessment. The AI models may include, without limitation, one or more large language models (LLMs), natural-language inference models, classifiers, ranking models, or hybrid ensembles. In some embodiments, the model is configured to evaluate the assertion based on affirmative evidence contained in the retrieved reference passages, to detect material contradictions among sources, and to abstain or mark the assertion as not verifiable when evidence is insufficient or ambiguous. The verification engine 1723 may further impose compute and retrieval budgets (e.g., limiting the number of retrieval calls) while permitting follow-on retrieval when needed to resolve a material ambiguity or contradiction.

The output of the AI model(s) is parsed into structured fields associated with the asserted statement. Example fields include a veracity score, a veracity category, an explanation (e.g., a brief natural-language rationale), and a confidence value and/or other metadata (e.g., recency/volatility indicator, evidence sufficiency indicator, or contradiction indicator). The structured fields may be stored in association with the asserted statement for later synchronized display and/or caching and reuse.

### Multi-Language and Multi-Format Pipeline

In some embodiments, the system is configured to extract asserted statements and generate veracity assessments for digital media content in a plurality of human languages. For example, the system may determine or infer a source language associated with the digital media content (e.g., based on transcript metadata, language codes, or automated language identification) and then perform extraction and verification using that language.

For audio/video content lacking an available transcript in the source language, the system may generate a transcript by applying an automated speech recognition process to the audio portion of the content, and then extract asserted statements from the resulting transcript. In some embodiments, verification engine 1723 operates directly in the source language, including constructing search queries and evaluating retrieved reference passages in that language. In other embodiments, the system may translate the transcript and/or extracted asserted statements into a canonical language used by verification engine 1723 and generate veracity assessments based on the translated text.

In certain embodiments, the system may store and reuse language configuration artifacts to reduce latency, such as caching translated prompt templates or other language-specific resources derived from a canonical version, and refreshing such cached translations when the canonical version changes. In some embodiments, user-facing interface text and legal disclosures are presented in a device or browser language that may differ from the media language.

In some embodiments, retrieval may be localized to improve relevance, for example by configuring a retrieval service to prioritize reference sources based on a geographic region associated with the user device and/or the media.

### DIFFERENT CONTENT FORMATS

In some embodiments, assertion extraction engine 1721 is configured to process a plurality of content formats, including, but not limited to, at least video content, audio content, and text content.
Video content: asserted statements may be extracted from text derived from the video, including transcripts/captions provided by a host platform or generated from the video's audio, including via audio-to-text LLMs (e.g., Whisper).
Audio content: asserted statements may be extracted by transcribing an audio stream into text and processing the resulting transcript, including as described directly above.
Text content: asserted statements may be extracted directly from text, for example text included in social media posts, article text, or transcript text.

### EXAMPLE WORKFLOWS

### Example 1—First User Watching a New Media Item

In an illustrative scenario, a first user initiates playback of a newly posted video on a host platform using client device 1600 executing a browser extension or application. Client device 1600 determines a media identifier for the video (e.g., a platform-specific video ID and/or canonical URL) and presents the video using the host platform's client-side interface. The client device 1600 obtains a transcript or captions for the video from the host platform or another transcript source; if a transcript is not available, the client device 1600 (or a service in communication with the client device) derives a transcript by transcribing an audio stream extracted from the video.

The system extracts one or more asserted statements from the transcript and associates each asserted statement with a corresponding time interval within the video. For each asserted statement, the system generates one or more search queries, retrieves reference passages from eligible reference sources (e.g., via a web retrieval service subject to reliability guardrails), and applies one or more AI models to generate a veracity assessment. The veracity assessment may include, for example, a veracity score, veracity category, explanation text, qualified ground-truth article URLs, and a confidence value or metadata. As playback proceeds, an overlay rendering component monitors the current playback time and, when the playback time falls within a time interval of a verified asserted statement, displays an indicator synchronized with the video. In embodiments employing dormant overlay logic, overlay renderer 1615 may remain hidden until at least one asserted statement satisfies a threshold condition (e.g., a significance or controversy score exceeds a predetermined threshold), after which the overlay transitions to an active state.

In this scenario, the system stores at least a portion of the outputs-such as the transcript, asserted statements, time intervals, and veracity assessments-in depersonalized cache of fact-check results 1725 in association with the media identifier. In some embodiments, the cached data is stored in a de-identified form keyed by the media identifier and is not persistently associated with a user identifier.

### Example 2—Later User Watching the Same Media Item

In a second illustrative scenario, a subsequent user later initiates playback of the same video. The client device 1600 again obtains the media identifier and checks whether cached results exist in depersonalized cache of fact-check results 1725 for that media identifier. When the cached transcript and veracity assessments remain valid under a refresh policy (e.g., a time-to-live policy that varies based on media age and/or per-assertion recency metadata), the client device 1600 retrieves the cached assessments at or near the start of playback. The overlay renderer 1615 can then display synchronized per-assertion indicators during playback without re-running the full verification pipeline for every asserted statement, thereby reducing latency and computational load.

If one or more cached per-assertion assessments are stale under the refresh policy (e.g., a soft TTL is exceeded), the system can display the cached indicator while initiating an asynchronous re-verification for that assertion (or for a segment containing the assertion), and can update the overlay when refreshed results are available. If a hard TTL is exceeded, the system can refresh the assertion (or segment) before presenting a refreshed result. In embodiments with segment-level refresh, when any assertion in a segment is designated time-sensitive, the system may re-verify the entire segment as a unit to improve consistency and efficiency. In all cases, cache updates are stored in association with the media identifier in a user-disassociated manner so that reuse benefits later viewers without revealing any particular viewer's watch history.

### LLM-Based Assertion Extraction

In some embodiments, assertion extraction engine 1721 identifies asserted statements from media-derived text (e.g., transcript or captions) using one or more artificial-intelligence models, including without limitation LLMs, classifiers, or hybrid systems. The engine provides the model with transcript text (optionally segmented and optionally accompanied by contextual inputs such as title, upload date, and language code) and instructions that cause the model to select a limited number of candidate asserted statements that are suitable for verification. Criteria for selecting limited assertions may include selecting factual statements only (or also opinions and/or predictions) that are most important to the argument made in the transcript, severity of impact if factually unsubstantiated, and/or their level of controversy. The model is further instructed to normalize each selected statement into a concise, fact-focused proposition and to associate each statement with a corresponding time interval in the media (e.g., derived from caption timecodes or alignment between transcript text and audio/video timing). The engine may also cause the model to output lightweight metadata useful for downstream processing, such as a recency/volatility indicator or other coarse classification.

The model returns a machine-parsable structured output (e.g., conforming to a predetermined schema) comprising a list of assertion records, each record including at least an assertion text field and a timing field, and optionally one or more metadata fields. Representative constraints may include: extracting an implementation-defined number of assertions per segment or per media item based on objective and unbiased selection criteria; limiting assertion length and complexity; and applying formatting constraints that enable deterministic parsing. In some embodiments, the engine removes or reduces attribution/reporting phrasing to isolate an underlying factual proposition, optionally retaining a compact attribution marker. Assertion extraction may be performed locally on client device 1600 or by a remote extraction service in communication with the client device, which returns structured assertion records for association with the media identifier and subsequent verification and synchronized display.

### LLM-Based Verification and Scoring

In some embodiments, verification engine 1723 generates veracity assessments for asserted statements using one or more artificial-intelligence models, including without limitation large language models (LLMs), classifiers, ranking models, or hybrid ensembles. For a given asserted statement, verification engine 1723 obtains candidate reference material by issuing one or more retrieval requests (e.g., web search or other network retrieval) using the asserted statement text and/or a reformulated query. The retrieved results may be filtered or weighted according to predetermined eligibility criteria (e.g., source reliability guardrails, recency constraints, language constraints, and relevance). The verification engine 1723 then provides the asserted statement together with selected retrieved passages (and optionally metadata such as publication dates or source identifiers) to an AI model via instructions that cause the model to compare the asserted statement against the reference material and to determine an assessment outcome.

The model returns a machine-parsable structured output (e.g., conforming to a predetermined schema) that includes fields representing a veracity score (numeric or other quantitative value), a veracity category selected from a predefined set, and a concise natural-language explanation; the output may further include a confidence value and/or verification metadata (e.g., indicators of evidence sufficiency, contradiction among sources, or time sensitivity). Representative constraints may include: limiting the number of retrieval calls per asserted statement; requiring the assessment to be supported by evidence contained in retrieved reference material and to abstain when evidence is insufficient; enforcing that the score falls within a predetermined range and is consistent with the selected veracity category; and enforcing length/format constraints for explanation text to enable deterministic parsing and consistent UI display. In some embodiments, verification engine 1723 may perform multiple evaluation passes (e.g., additional retrieval or secondary model calls) when a material ambiguity or contradiction is detected, and may produce the final assessment by applying implementation-defined aggregation rules to one or more model outputs. Some embodiments may enforce cross-referencing verifications across more than one independent qualified source.

### EXAMPLE USE CASES

As a first use example, consider a user watching a political debate on a popular video streaming platform. As a candidate makes a statement regarding their economic record, an embodiment of the invention identifies this assertion, verifies it against multiple authoritative data sources, and displays a real-time assessment indicating whether the assertion is correct, misleading, or false.

As a second use example, consider the user reading a (displayed) news article containing medical information. While the user is reading, an embodiment of the invention may highlight an assertion about a new treatment and display a factual correctness rating and three authoritative references (e.g., links to two different respected medical journals and a renowned medical center's website), allowing the user to instantly gauge the reliability of the information. In aggregated form, the overall quality of a video, based on dozens of extracted and fact-checked assertions, could be seen before a viewer decides whether or not to watch the video, along with a high-level rationale specific to that video; the video-level score and short rationale can be shown in an overlay panel, in the manner of a tooltip, upon hovering over a video thumbnail on a social media platform. At one level higher, the summary scores of an adequate sample of videos from a specific social media channel (from a given content creator or business or news medium) could yield an overall “channel accuracy ranking,” informing users of that channel's historical reliability over a rolling look-back period.

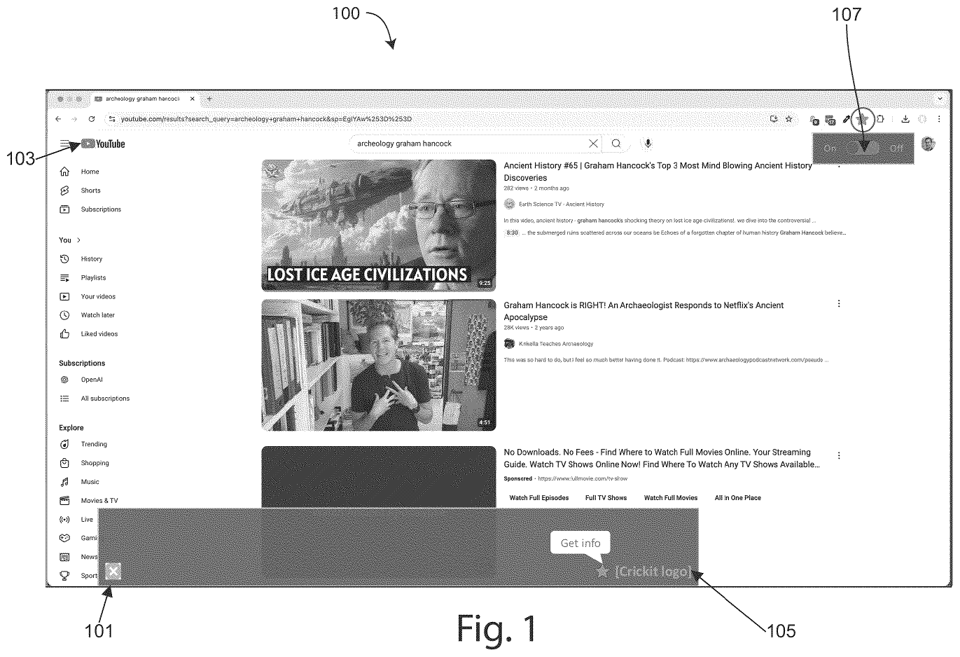

FIGS. 1-15 each show an image representing at least a portion of display 1607 of client device when executing least one of the programs 1605 as part of the system architecture and data flow 1700. Specifically, each of the images of FIGS. 1-15 illustrate the effect of a user interacting with a browser application's user interface on client device 1600 in accordance with one or more embodiments described herein. By way of example and without limitation, client device 1600 in FIGS. 1-15 illustrates the fact-checking of a YouTube video, with the display of overlay panels displayed by the overlay renderer 1615. FIGS. 1-15 are provided to assist in understanding the disclosed embodiments and are not intended to limit the scope of the invention except as expressly set forth in the claims.

FIG. 1 is an image 100 illustrating that clicking on the extension in a video displays fact checking panel and the on-off toggle. Image 100 thus shows a veracity-grading web browser overlay 101 positioned above a host social media platform 103. The presence of a company logo 105 in overlay 101 indicates that the browser application is separate from the host platform's website. Image 100 also shows an on-off toggle 107 which a user may use to deactivate or activate fact-checking capabilities. The presence of, and information within, overlay 101 changes during operation, as described herein.

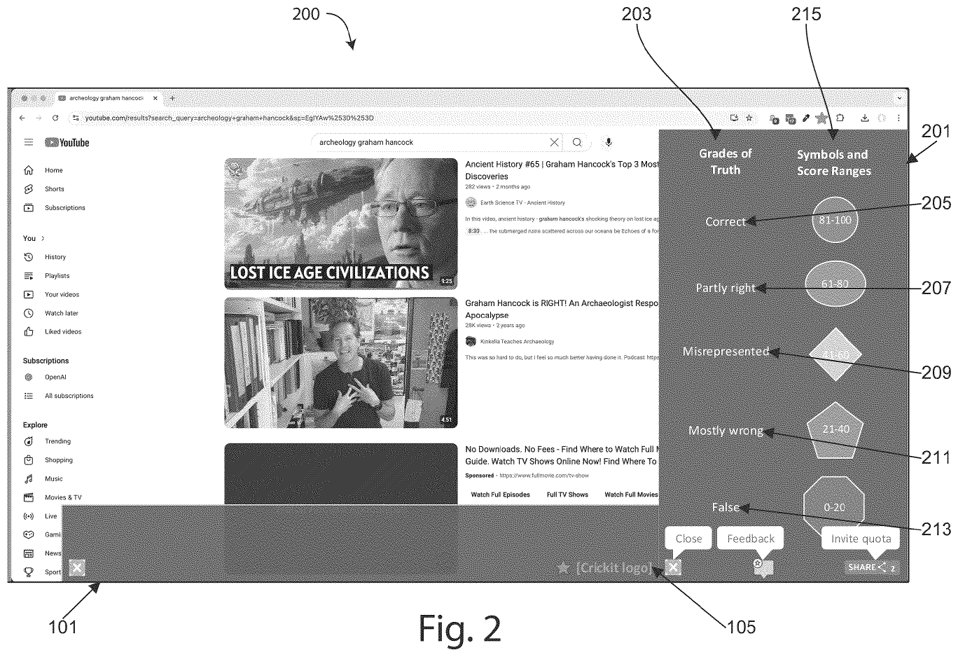

FIG. 2 is an image 200 illustrating that clicking on a company logo 105 placeholder displays the scoring game legend, which corresponds to the logic, for example and without limitation, used in verification engine 1723. Image 200 thus shows a second overlay 201 including a legend for a veracity-scoring system, which categorizes assertions of “Grades of Truth” 203, which may include, for example and without limitation, the categories of “Correct” 205, “Partly Right” 207, “Misrepresented” 209, “Mostly Wrong” 211, or “False” 213 according to an embodiment of the invention. In one such embodiment, each category is assigned a score range, indicated as “Symbols and Score Ranges” 215.

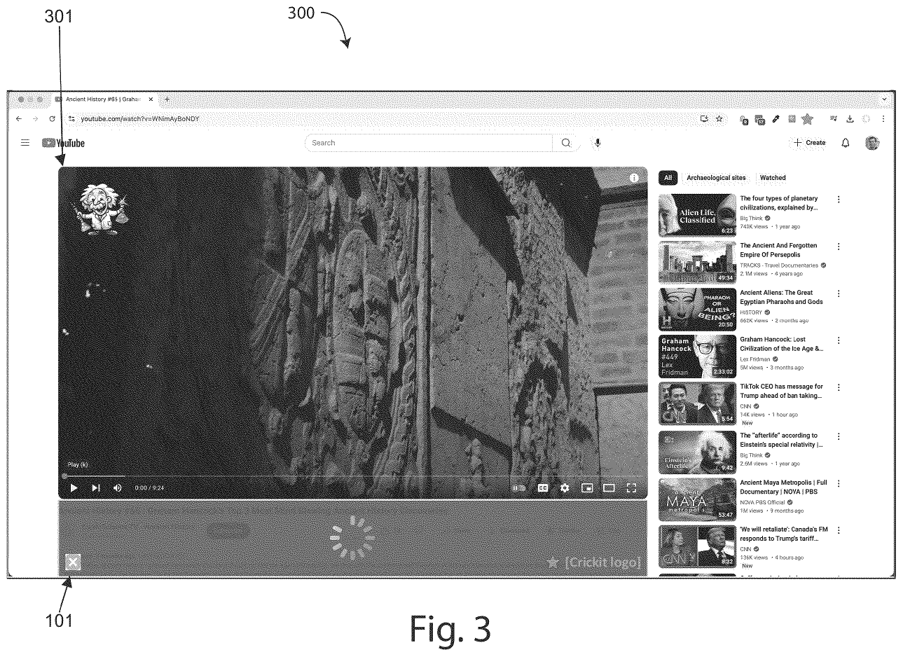

FIG. 3 is an image 300 illustrating that playing a video brings up the overlay display. Image 300 thus shows that the browser extension is activated upon playing a video 301 on the host platform and displaying a real-time assertion evaluation panel overlay 101 during video playback, according to an embodiment of the invention. In certain embodiments, fact-checking takes one or more seconds to load before being immediately available for synchronous, subtitle-like overlays, according to one embodiment.

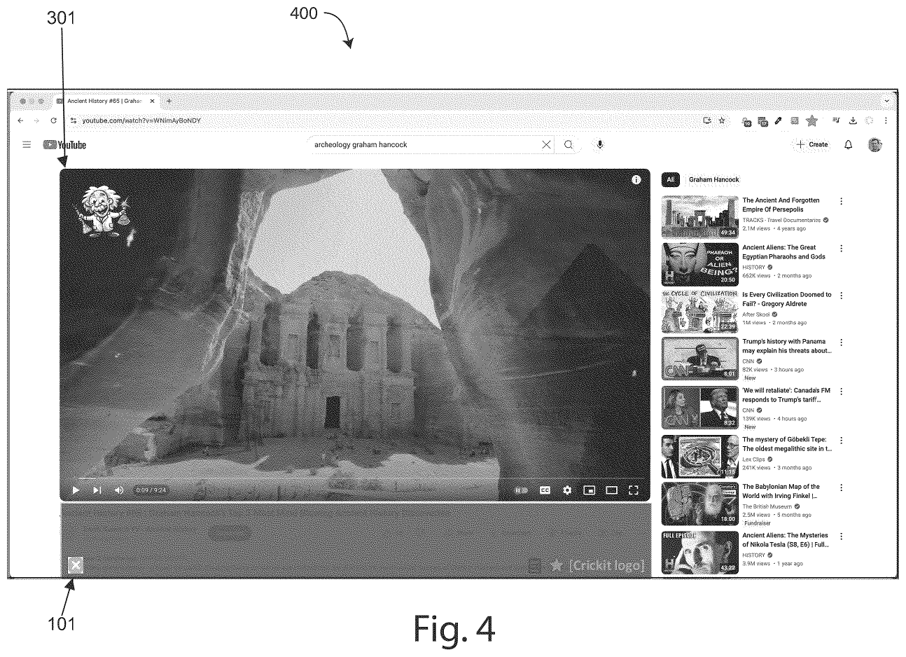

FIG. 4 is an image 400 illustrating that a video plays normally when there are no major or controversial assertions, as determined, for example and without limitation by assertion extraction engine 1721. Image 400 thus shows an example of a video playing 301 with no significant or controversial assertions detected, according to an embodiment of the invention.

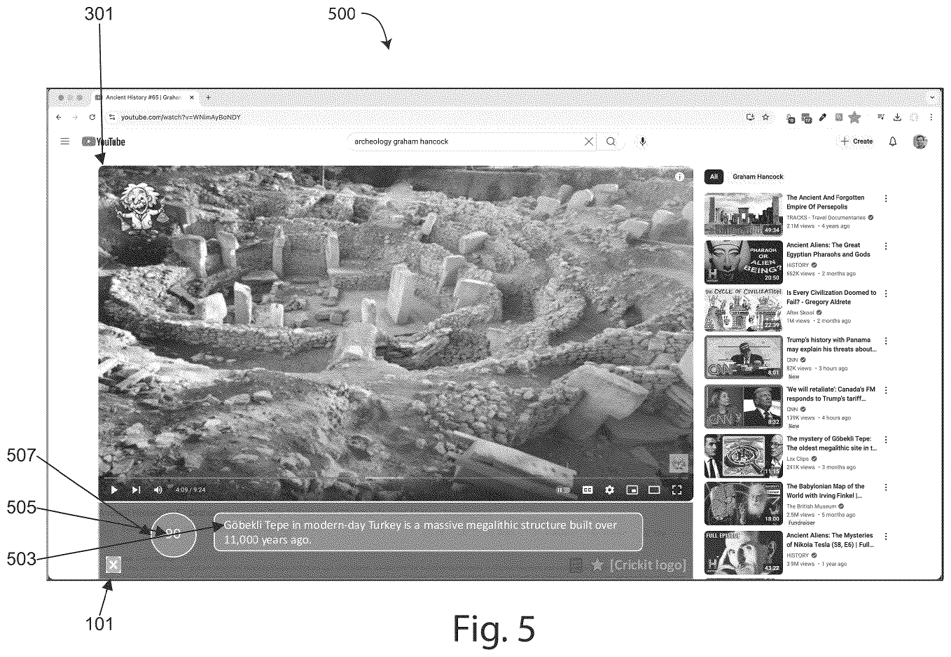

FIG. 5 is an image 500 illustrating video 301 playing during an assertion that is “Correct.” Image 500 illustrates that overlay 101 may, for example and limitation, present information related to a single assertion during time-synchronized with video playback period. Overlay 101 in image 500, overlayed on video 301, that includes, for example and without limitation, a lightly paraphrased assertion text 503, a score 505, and a veracity category 507, where 503 may be determined, for example and without limitation by assertion extraction engine 1721, and where 505 and 507 may be determined, for example and without limitation, by verification engine 1723.

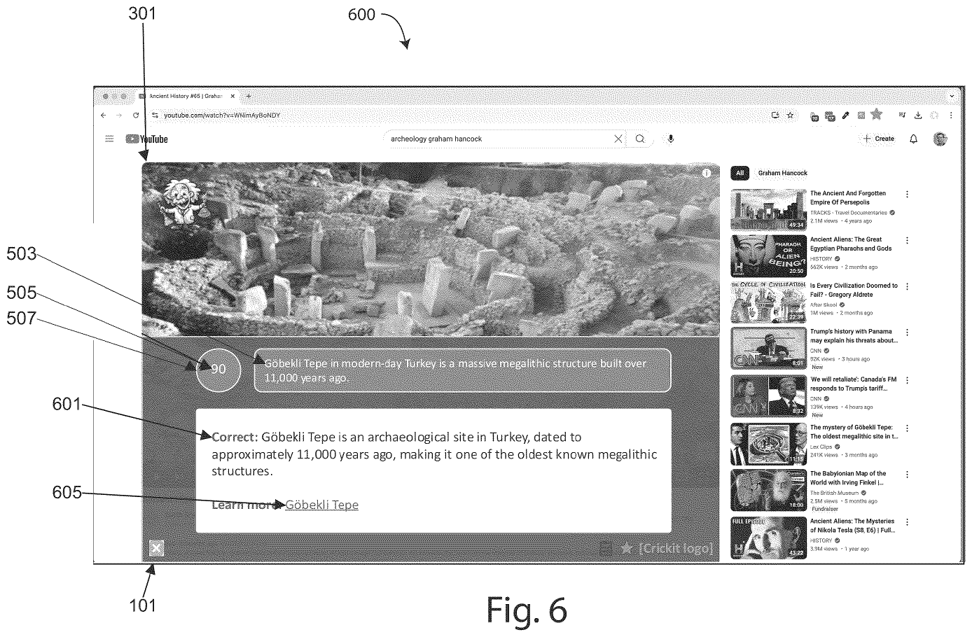

FIG. 6 is an image 600 illustrating that pausing video 301 in FIG. 5 expands the information in overlay 101. Thus, image 600 shows that pausing video 301 enhances the presentation of lightly paraphrased assertion text 503, score 505, and veracity category 507, with the addition of a short, context-specific explanation 601 and URL link(s) 605 to ground-truth articles for the user to verify and learn more. Context-specific explanation 601 and URL link(s) 605 may be determined, for example and without limitation by assertion extraction engine 1721 and verification engine 1723.

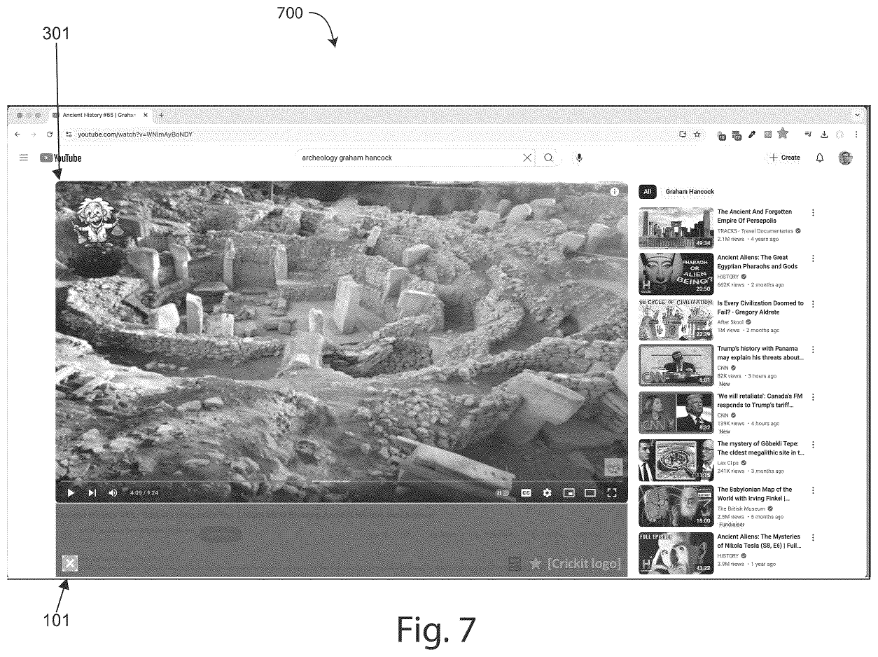

FIG. 7 is an image 700 illustrating that clicking on video 301 may restart the video, thereby collapsing the context-specific explanation 601 and URL link(s) 605, and also illustrating that the lightly paraphrased assertion text 503, score 505, and veracity category 507 may disappear after the video advances past the stop timestamp of the assertion extracted by assertion extraction engine 1721.

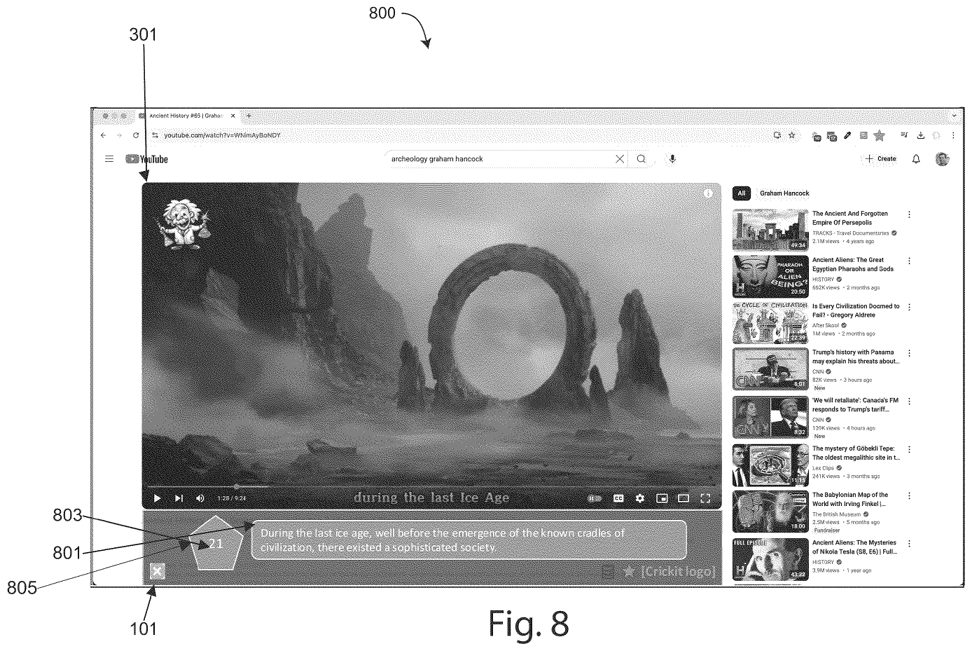

FIG. 8 is an image 800 illustrating the occurrence of an assertion that is “Mostly Wrong.” Thus, image 800 shows that when a major assertion in video 301 determined to be “Mostly Wrong,” overlay 101 includes the assertion's text 801, veracity score 803, and veracity category 805 according to an embodiment of the invention. The assertion's text 801, veracity score 803, and veracity category 805 may be determined, for example and without limitation by assertion extraction engine 1721 and verification engine 1723.

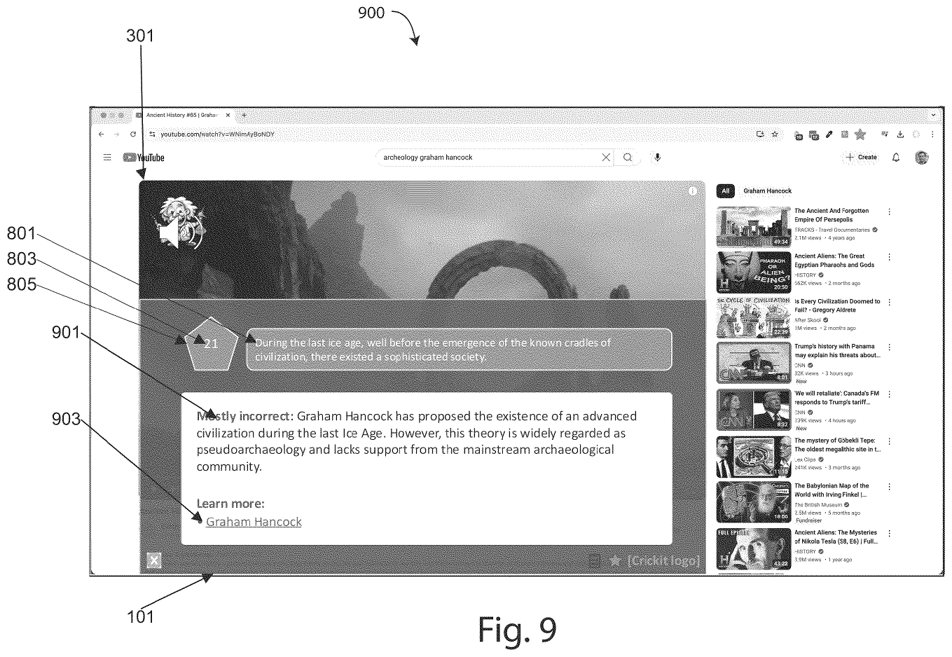

FIG. 9 is an image 900 illustrating that pausing video 301 in FIG. 8 expands the information in in overlay 101. Thus, image 900 shows that pausing video 301 enhances the presentation of assertion's text 801, veracity score 803, and veracity category 805 with the addition of a detailed explanation 901 for the displayed assertion and URL link(s) 903 to ground-truth articles for the user to verify and learn more. Detailed explanation 901 and URL link(s) 903 may be determined, for example and without limitation by assertion extraction engine 1721 and verification engine 1723.

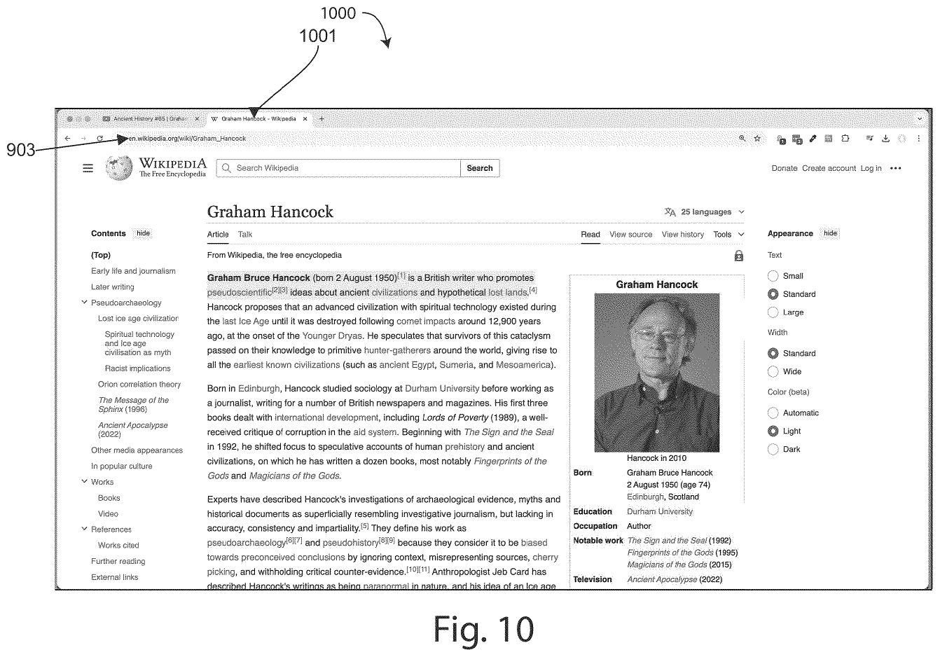

FIG. 10 is an image 1000 illustrating that clicking on a link opens a new web browser. Thus, image 1010 shows that clicking on a link 903 pops open a new web browser tab 1001 that navigates to the ground-truth article.

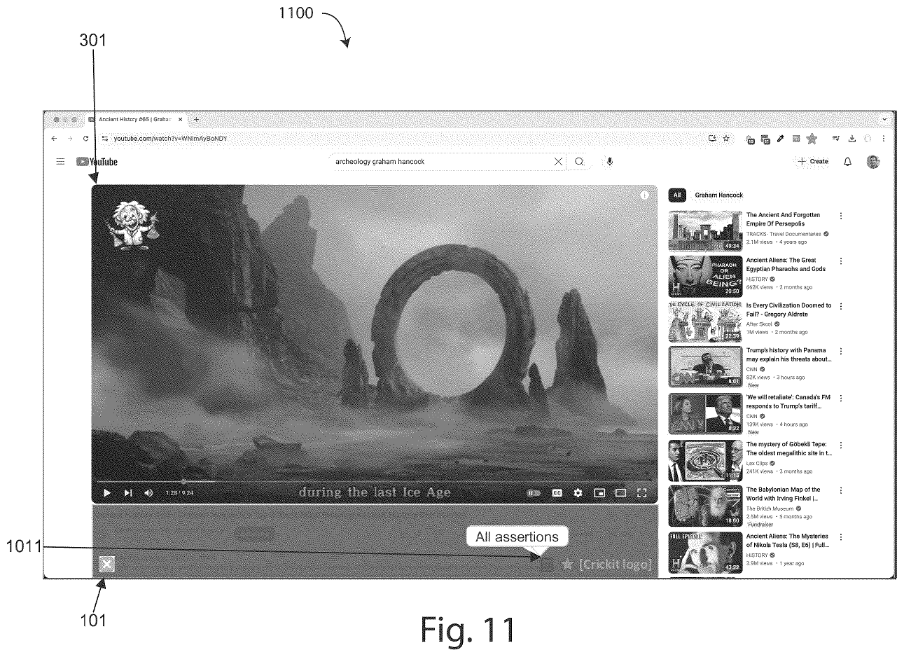

FIG. 11 is an image 1100 illustrating an “All assertions” button 1011 within overlay 101.

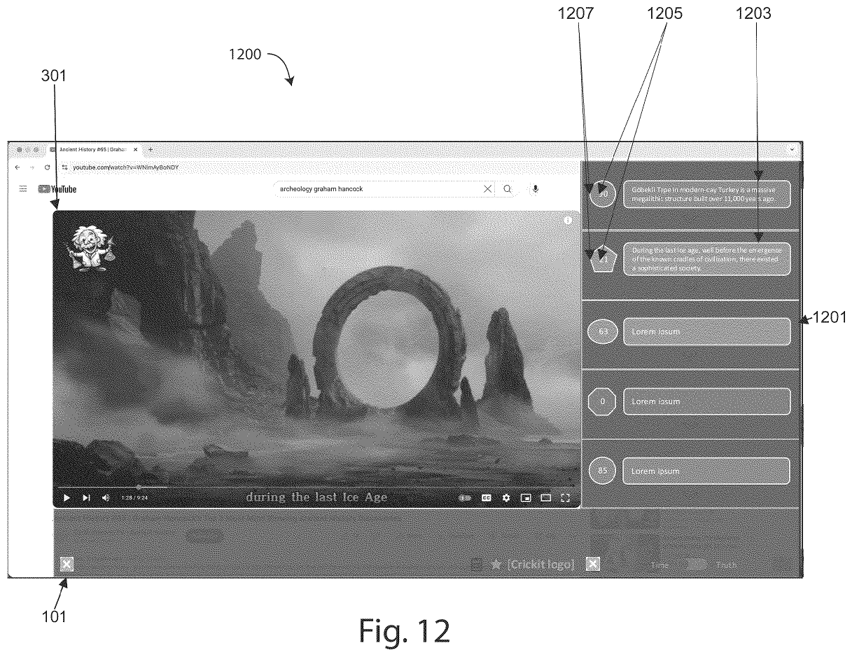

FIG. 12 is an image 1200 illustrating the effect of clicking on “All assertions” button 1011 illustrated in FIG. 11. Thus, image 1200 shows that clicking on “All assertions” button 1011 opens overlay 1201, which includes a list, for video 301, of all verified assertions and their veracity scores and veracity categories as obtained from either the assertion verification engine 1723 or from the depersonalized cache of fact-check results 1725 (depending on whether another user has verified the relevant claims in video 301 recently enough for them to remain in the cache).

Overlay 1201 differs from overlay 101 in that it is an “All assertions” overlay that contains all the fully processed lightly paraphrased assertion text 1203, scores 1205, and veracity categories 1207 in video 301 with the information. Each of lightly paraphrased assertion text 1203, scores 1205, and veracity categories 1207 are similar, for example and without limitation, to lightly paraphrased assertion text 503, score 505, and veracity category 507, or to assertion text 801, veracity score 803, and veracity category 805 as discussed above. In accordance with one embodiment, list of all verified assertions 1201 may be sorted either chronologically (in their order of appearance) or by veracity scores.

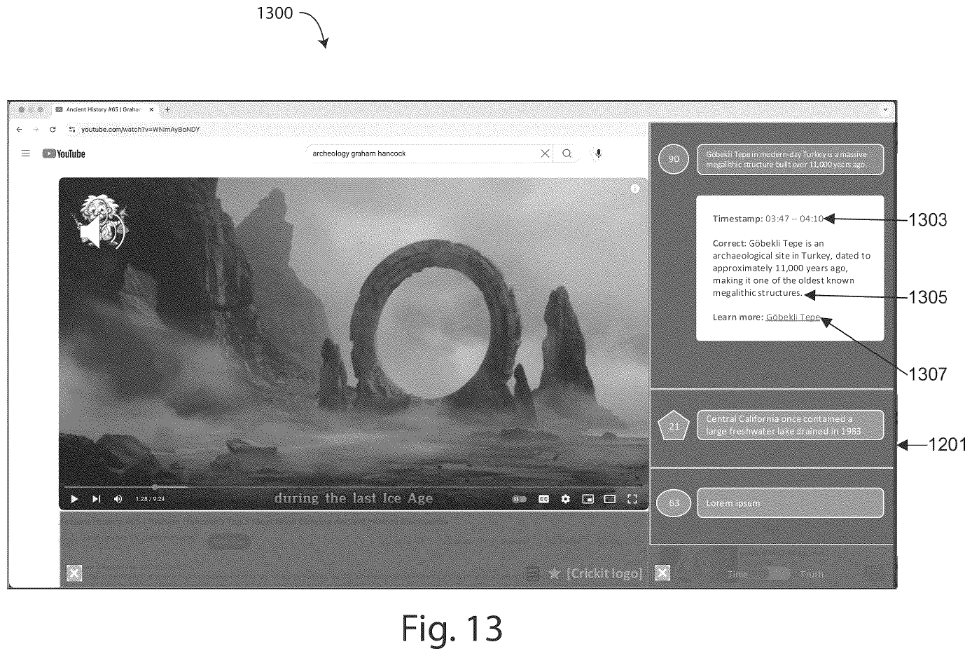

FIG. 13 is an image 1300 illustrating that each assertion can expand to show timestamps, explanations, and links without altering the video. Thus, image 1300 shows that clicking on the first assertion of FIG. 12 expands overlay 1201 to include a timestamp 1303, a short explanation 1305, and ground-truth-article links 1307, where the short explanation 1305, and ground-truth-article links 1307 are obtained from either the assertion verification engine 1723 or from the depersonalized cache of fact-check results 1725 (depending on whether another user has verified the relevant claims in video 301 recently enough for them to remain in the cache).

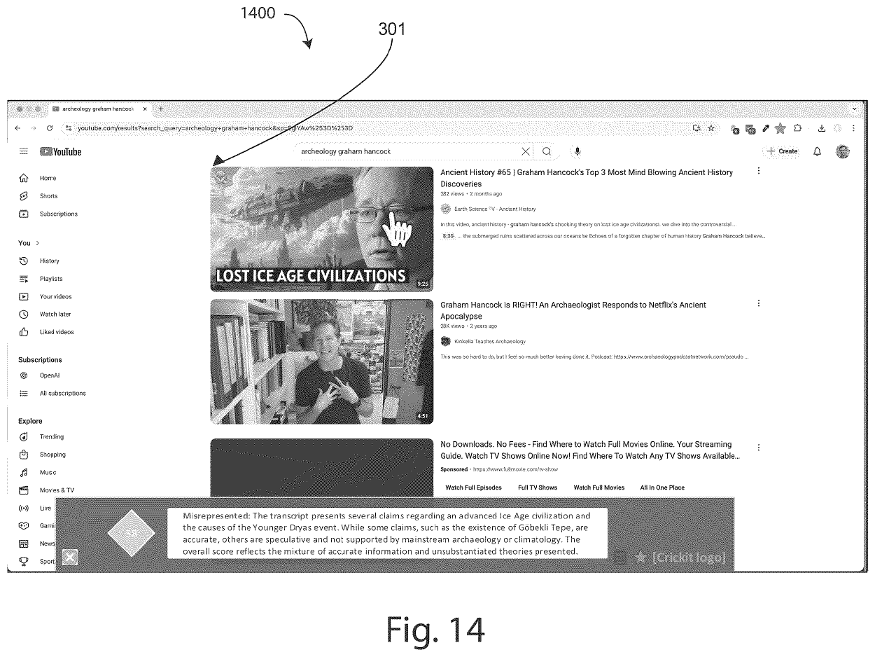

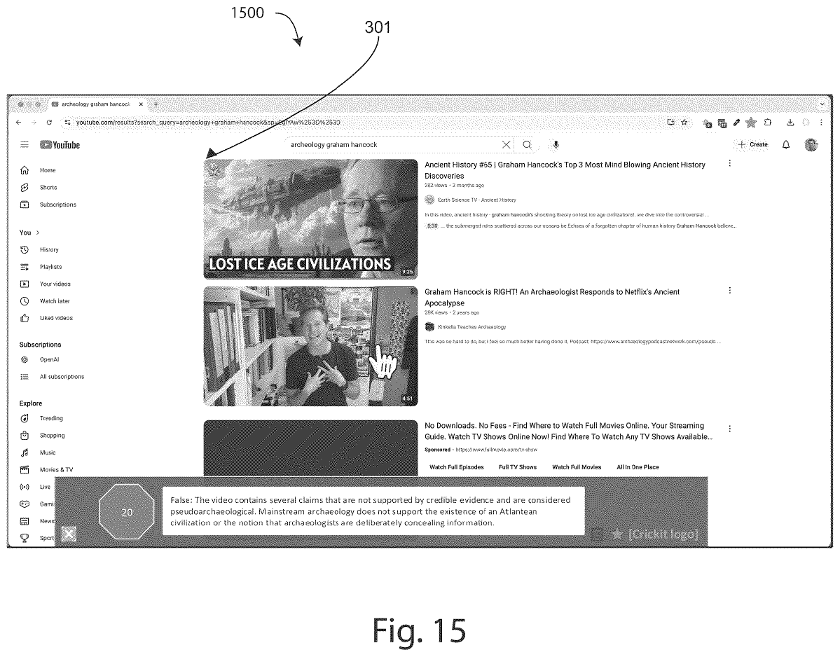

FIG. 14 and FIG. 15 are image 1400 and image 1500, respectively illustrating how, after one user of the application has already opened and fully fact-checked a video, other users can immediately see overall scores and explanations associated with said video's thumbnail, before the other users decide whether they desire to actually view the already scored and summarized video. Thus, image 1400 and image 1500 show that after a user has opened video (e.g., video 301), the fact-checking content is in a database (e.g., for between three hours and six months, depending on the age and type of content) so that other users may see an overall score and explanation immediately, before viewing the media content. This functionality can slow the spread of harmful misinformation and disinformation.

### Fact Checking Performance and Accuracy

In some embodiments, system performance may be evaluated using benchmark tasks or test corpora; results may vary based on implementation details, reference sources, model configurations, and operating conditions.

In one test of fact checking performance and accuracy, a benchmark based on an adapted AVeriTeC Supported/Refuted task, Crickit achieved 98.7% average accuracy (0.9871) after evaluation against updated and corrected labels (reflecting a judge-model review with web grounding and human review). This figure is described as a product-track estimate (not an official AVeriTeC leaderboard score).

To illustrate practical impact on real social-media viewing, Crickit analyzed a small, clearly specified sample of 125 asserted statements extracted from top-viewed “US news” YouTube videos. Under the paper's stated assumptions and, the expected share of problematic asserted statements (rated as “Misrepresented”, “Mostly Wrong”, or “False”) encountered by viewers falls from ~32.0% (about one in three) to ~1.0% (about one in a hundred), a ~32-fold reduction in exposure to problematic asserted statements relative to the status quo without Crickit (https://crickit.ai/wp-content/uploads/2025/11/Benchmarking-the-Accuracy-of-Crickit.pdf).

The foregoing performance metrics and evaluation results are provided solely as illustrative examples of possible system behavior and performance, and are not intended to be limiting, exhaustive, or required for enablement of the disclosed embodiments. Actual performance may vary depending on implementation details, reference sources, model configurations, and operating conditions.

### Scalability and Adaptability

Embodiments of the invention can be integrated across various digital platforms, devices, and content forms. the method and system of the invention can scale to handle large volumes of media in different languages, leveraging advancements in NLP, LLMs, and cloud-based verification APIs. Modular implementation ensures that as new verification sources or improved AI models become available, they can be readily incorporated into an embodiment of the invention without disrupting the host platforms or requiring specialized partnerships or agreements with the media providers. The caching architecture may also scale by applying incremental updates to previously verified segments (evicting expired fact-checks from client cache 1617 and replacing them with new ones), storing them for efficient reuse across diverse user sessions and platform integrations.

### Possible Advantages

Modern media ecosystems have evolved from singular, authoritative broadcasts into highly decentralized networks, where billions of voices compete for attention and influence. This shift has dramatically increased access to diverse perspectives but has also lowered barriers for spreading misinformation and disinformation at unprecedented speed and scale. To address this urgent challenge, embodiments of the present invention may provide a scalable, flexible, and user-friendly method for delivering real-time veracity assessments of assertions within digital and social media environments. By operating non-invasively and seamlessly alongside existing platforms—without altering their underlying design, code, or services—and by leveraging reputable external sources and powerful AI-driven verification engines, embodiments of the present invention may enable synchronized, transparent fact-checking directly in the user's media consumption flow.

Using an embodiment of the present invention, instead of requiring audiences to leave their media environment or rely on delayed, external fact-checking resources, users may gain immediate, contextualized insights into the credibility of the information they encounter. This innovation restores accountability and trust to the public discourse, fostering a more informed, resilient, and discerning public. By encouraging the elevation of accurate, evidence-based content and promoting a more responsible, trustworthy, and constructive exchange of ideas, human societies can more effectively collaborate to solve important challenges. Additionally, the capacity of embodiments of the present invention for caching fact-checking results and generating channel-level accuracy rankings may broaden its applicability, providing users and organizations with ongoing insights into the reliability of both individual assertions and larger content ecosystems.

Unless specifically stated otherwise, as apparent from the following discussions, it is appreciated that throughout the specification discussions utilizing terms such as “processing,” “computing,” “calculating,” “determining” or the like, refer to the action and/or processes of a host device or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory.

The methodologies described herein are, in one embodiment, performable by one or more digital processors that accept machine-readable instructions, e.g., as firmware or as software, that when executed by one or more of the processors carry out at least one of the methods described herein. In such embodiments, any processor capable of executing a set of instructions (sequential or otherwise) that specify actions to be taken may be included. Thus, one example is a programmable DSP device. Another is the CPU of a microprocessor or other computer-device, or the processing part of a larger ASIC. A digital processing system may include a memory subsystem including main RAM and/or a static RAM, and/or ROM. A bus subsystem may be included for communicating between the components. The digital processing system further may be a distributed digital processing system with processors coupled wirelessly or otherwise, e.g., by a network. The digital processing system in some configurations may include a sound input device, and a sound output device. The memory subsystem thus includes a machine-readable non-transitory medium that is coded with, i.e., has stored therein a set of instructions to cause performing, when executed by one or more digital processors, one of more of the methods described herein. Note that when the method includes several elements, e.g., several steps, no ordering of such elements is implied, unless specifically stated. The instructions may reside in the hard disk, or may also reside, completely or at least partially, within the RAM and/or other elements within the processor during execution thereof by the system. Thus, the memory and the processor also constitute the non-transitory machine-readable medium with the instructions.

Furthermore, a non-transitory machine-readable medium may form a software product. For example, it may be that the instructions to carry out some of the methods, and thus form all or some elements of the inventive system or apparatus, may be stored as firmware. A software product may be available that contains the firmware, and that may be used to “flash” the firmware.

Note that while some diagram(s) only show(s) a single processor and a single memory that stores the machine-readable instructions, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a non-transitory machine-readable medium coded with, i.e., having stored therein a set of instructions for execution on one or more digital processors, e.g., one or more digital processors that are part of the receiver forming a pen stroke capture system.

Note that, as is understood in the art, a machine with application-specific firmware for carrying out one or more aspects of the invention becomes a special purpose machine that is modified by the firmware to carry out one or more aspects of the invention. This is different than a general purpose digital processing system using software, as the machine is especially configured to carry out the one or more aspects. Furthermore, as would be known to one skilled in the art, if the number the units to be produced justifies the cost, any set of instructions in combination with elements such as the processor may be readily converted into a special purpose ASIC or custom integrated circuit. Methodologies and software have existed for years that accept the set of instructions and particulars of, for example, the processing engine 131, and automatically or mostly automatically great a design of special-purpose hardware, e.g., generate instructions to modify a gate array or similar programmable logic, or that generate an integrated circuit to carry out the functionality previously carried out by the set of instructions. Thus, as will be appreciated by those skilled in the art, embodiments of the present invention may be embodied as a method, an apparatus such as a special purpose apparatus, an apparatus such as a data DSP device plus firmware, or a non-transitory machine-readable medium. The machine-readable carrier medium carries host device readable code including a set of instructions that when executed on one or more digital processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form a computer program product on a non-transitory machine-readable storage medium encoded with machine-executable instructions.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures, or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following asserted statements, any of the claimed embodiments can be used in any combination.

Furthermore, some of the embodiments are described herein as a method or combination of elements of a method that can be implemented by a processor of a host device system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Any discussion of prior art in this specification should in no way be considered an admission that such prior art is widely known, is publicly known, or forms part of the general knowledge in the field.

In the claims below and the description herein, any one of the terms comprising, comprised of or which comprises is an open term that means including at least the elements/features that follow, but not excluding others. Thus, the term comprising, when used in the asserted statements, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the asserted statements, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Note that the claims attached to this description form part of the description, so are incorporated by reference into the description, each claim forming a different set of one or more embodiments. In jurisdictions where incorporation by reference is not permitted, the applicant reserves the right to add such asserted statements, forming part of the specification.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

1. A computer-implemented method for real-time verification of asserted statements during consumption of digital media, comprising:
(a) presenting, at a client device, digital media content supplied by a host platform within a continuous media feed, playback page, or reading view;
(b) identifying, during presentation of the digital media content, one or more asserted statements expressed in the digital media content;
(c) verifying at least a subset of the asserted statements against information obtained from one or more external reference sources to generate, for each verified asserted statement, a veracity assessment;
(d) during ongoing presentation of the digital media content, displaying the veracity assessment for a verified asserted statement in temporal alignment with the asserted statement, as an overlay that appears in a subtitles-like manner while the asserted statement is presented; and
(e) performing the displaying without requiring modification of source code of the host platform, without requiring a partnership or privileged integration with the host platform, and without requiring a user to leave the feed, page, or tab in which the digital media content is presented.

2. The method of claim 1, wherein identifying the one or more asserted statements comprises extracting, in real time, a plurality of asserted statements from the digital media content using an assertion extraction engine executed by the client device or by a computing system in communication with the client device, the assertion extraction engine being configured to process at least one of text derived from the digital media content, audio of the digital media content, or visual frames of the digital media content from which textual content is derived, and associating each asserted statement with a corresponding time interval of the digital media content.

3. The method of claim 1, wherein verifying at least the subset of the asserted statements comprises:
(a) obtaining information from one or more external reference sources selected from a curated set of reference sources determined, according to predetermined criteria, to provide factual information, wherein the obtaining information comprises issuing one or more search queries to a network retrieval service, including a web search engine, to retrieve passages or documents from the one or more external reference sources; and
(b) analyzing the obtained information using one or more automated verification algorithms or artificial-intelligence models to generate the veracity assessment for each verified asserted statement.

4. The method of claim 3, wherein generating the veracity assessment comprises assigning a numeric veracity score and/or a veracity category selected from a predefined set of categories, and storing the veracity assessment in association with the corresponding time interval of the digital media content.

5. The method of claim 3, wherein verifying the asserted statements further comprises utilizing structured prompts to one or more large language models to derive a quantitative veracity score and the veracity category, and incorporating contextual metadata into the veracity assessment, the contextual metadata comprising at least one of a number of reference sources used, a confidence level associated with the veracity score, or a timestamp indicating when verification was last performed.

6. The method of claim 1, wherein displaying the veracity assessment comprises presenting the veracity assessment via at least one of a browser extension, a mobile application, or another client-side overlay mechanism synchronized with media playback timestamps, and expanding the synchronized overlay in response to user interaction to display additional details including a rationale for the veracity assessment.

7. The method of claim 1, wherein the synchronized overlay remains visually dormant during playback unless at least one verified asserted statement satisfies a threshold condition based on a significance or controversy score exceeding a predetermined threshold.

8. The method of claim 1, wherein identifying and verifying the asserted statements are performed for digital media content in a plurality of human languages, and wherein the assertion extraction engine is configured to process a plurality of content formats including video content, audio content, and text content.

9. The method of claim 1, further comprising caching veracity assessment results associated with the digital media content in a storage medium indexed by a media identifier, and upon a subsequent request to present the digital media content identified by the media identifier, retrieving the cached veracity assessment results to present at least one of a synchronized overlay for previously verified asserted statements or an aggregate indication of veracity for the digital media content.

10. The method of claim 1, further comprising aggregating veracity scores from multiple verified pieces of digital media content associated with a same publisher or channel identifier, computing an overall reliability score based on the aggregated veracity scores, and presenting an indication of the overall reliability score in association with digital media content from the publisher or channel.

11. A system for real-time verification of asserted statements during consumption of digital media, comprising:
one or more processors; and
one or more non-transitory computer-readable media storing instructions that, when executed by the one or more processors, cause the system to:
(a) present, at a client device, digital media content supplied by a host platform within a continuous media feed, playback page, or reading view;
(b) identify, during presentation of the digital media content, one or more asserted statements expressed in the digital media content;
(c) verify at least a subset of the asserted statements against information obtained from one or more external reference sources to generate, for each verified asserted statement, a veracity assessment;
(d) during ongoing presentation of the digital media content, display the veracity assessment for a verified asserted statement in temporal alignment with the asserted statement, as an overlay that appears in a subtitles-like manner while the asserted statement is presented; and
(e) perform the displaying without modifying source code of the host platform, without requiring a partnership or privileged integration with the host platform, and without requiring a user to leave the feed, page, or tab in which the digital media content is presented.

12. The system of claim 11, wherein identifying the one or more asserted statements comprises an assertion extraction engine configured to extract, in real time, a plurality of asserted statements from the digital media content by processing at least one of text derived from the digital media content, audio of the digital media content, or visual frames of the digital media content from which textual content is derived, and to associate each asserted statement with a corresponding time interval of the digital media content.

13. The system of claim 11, wherein verifying at least the subset of the asserted statements comprises:
(a) obtaining information from one or more external reference sources selected from a curated set of reference sources determined, according to predetermined criteria, to provide factual information, wherein the obtaining the information comprises one or more search queries to a network retrieval service, including a web search engine, to retrieve passages or documents from the one or more external reference sources; and
(b) analyzing the obtained information using one or more automated verification algorithms or artificial-intelligence models to generate the veracity assessment for each verified asserted statement.

14. The system of claim 13, wherein generating the veracity assessment comprises assigning a numeric veracity score and/or a veracity category selected from a predefined set of categories, and storing the veracity assessment in association with the corresponding time interval of the digital media content.

15. The system of claim 13, wherein verifying the asserted statements further comprises utilizing structured prompts to one or more large language models to derive a quantitative veracity score and the veracity category, and incorporating contextual metadata into the veracity assessment, the contextual metadata comprising at least one of a number of reference sources used, a confidence level associated with the veracity score, or a timestamp indicating when verification was last performed.

16. The system of claim 11, wherein displaying the veracity assessment comprises presenting the veracity assessment via at least one of a browser extension, a mobile application, or another client-side overlay mechanism synchronized with media playback timestamps, and expanding the synchronized overlay in response to user interaction to display additional details including a rationale for the veracity assessment.

17. The system of claim 11, wherein the synchronized overlay remains visually dormant during playback unless at least one verified asserted statement satisfies a threshold condition based on a significance or controversy score exceeding a predetermined threshold.

18. The system of claim 11, wherein identifying and verifying the asserted statements are performed for digital media content in a plurality of human languages, and wherein the assertion extraction engine is configured to process a plurality of content formats including video content, audio content, and text content.

19. The system of claim 11, further comprising a storage medium storing cached veracity assessment results associated with the digital media content indexed by a media identifier, and wherein the system is configured, upon a subsequent request to present the digital media content identified by the media identifier, to retrieve the cached veracity assessment results and present at least one of:
(a) a synchronized overlay for previously verified asserted statements; or
(b) an aggregate indication of veracity for the digital media content.

20. The system of claim 11, wherein the system is further configured to aggregate veracity scores from multiple verified pieces of digital media content associated with a same publisher or channel identifier, compute an overall reliability score based on the aggregated veracity scores, and present an indication of the overall reliability score in association with digital media content from the publisher or channel.

21. A non-transitory computer-readable medium storing instructions that, when executed by one or more processors of a client device or a computing system in communication with the client device, cause the one or more processors to:
(a) present, at the client device, digital media content supplied by a host platform within a continuous media feed, playback page, or reading view;
(b) identify, during presentation of the digital media content, one or more asserted statements expressed in the digital media content;
(c) verify at least a subset of the asserted statements against information obtained from one or more external reference sources to generate, for each verified asserted statement, a veracity assessment;
(d) during ongoing presentation of the digital media content, display the veracity assessment for a verified asserted statement in temporal alignment with the asserted statement, as an overlay that appears in a subtitles-like manner while the asserted statement is presented; and
(e) perform the displaying without modifying source code of the host platform, without requiring a partnership or privileged integration with the host platform, and without requiring a user to leave the feed, page, or tab in which the digital media content is presented.

22. The non-transitory computer-readable medium of claim 21, wherein identifying the one or more asserted statements comprises extracting, in real time, a plurality of asserted statements from the digital media content using an assertion extraction engine configured to process at least one of text derived from the digital media content, audio of the digital media content, or visual frames of the digital media content from which textual content is derived, and to associate each asserted statement with a corresponding time interval of the digital media content.

23. The non-transitory computer-readable medium of claim 21, wherein verifying at least the subset of the asserted statements comprises:
(a) obtaining information from one or more external reference sources selected from a curated set of reference sources determined, according to predetermined criteria, to provide factual information, wherein obtaining the information comprises issuing one or more search queries to a network retrieval service, including a web search engine, to retrieve passages or documents from the one or more external reference sources; and
(b) analyzing the obtained information using one or more automated verification algorithms or artificial-intelligence models to generate the veracity assessment for each verified asserted statement.

24. The non-transitory computer-readable medium of claim 23, wherein generating the veracity assessment comprises assigning a numeric veracity score and/or a veracity category selected from a predefined set of categories, and storing the veracity assessment in association with the corresponding time interval of the digital media content.

25. The non-transitory computer-readable medium of claim 23, wherein verifying the asserted statements further comprises utilizing structured prompts to one or more large language models to derive a quantitative veracity score and the veracity category, and incorporating contextual metadata into the veracity assessment, the contextual metadata comprising at least one of a number of reference sources used, a confidence level associated with the veracity score, or a timestamp indicating when verification was last performed.

26. The non-transitory computer-readable medium of claim 21, wherein displaying the veracity assessment comprises presenting the veracity assessment via at least one of a browser extension, a mobile application, or another client-side overlay mechanism synchronized with media playback timestamps, and expanding the synchronized overlay in response to user interaction to display additional details including a rationale for the veracity assessment.

27. The non-transitory computer-readable medium of claim 21, wherein the synchronized overlay remains visually dormant during playback unless at least one verified asserted statement satisfies a threshold condition based on a significance or controversy score exceeding a predetermined threshold.

28. The non-transitory computer-readable medium of claim 21, wherein identifying and verifying the asserted statements are performed for digital media content in a plurality of human languages, and wherein the assertion extraction engine is configured to process a plurality of content formats including video content, audio content, and text content.

29. The non-transitory computer-readable medium of claim 21, further storing instructions that cause the one or more processors to:
cache veracity assessment results associated with the digital media content in a storage medium indexed by a media identifier; and
upon a subsequent request to present the digital media content identified by the media identifier, retrieve the cached veracity assessment results and present at least one of:
(a) a synchronized overlay for previously verified asserted statements; or
(b) an aggregate indication of veracity for the digital media content.

30. The non-transitory computer-readable medium of claim 21, further storing instructions that cause the one or more processors to:
aggregate veracity scores from multiple verified pieces of digital media content associated with a same publisher or channel identifier;
compute an overall reliability score based on the aggregated veracity scores; and
present an indication of the overall reliability score in association with digital media content from the publisher or channel.
